(19) United States
(12) Patent Application Publication
(10) Pub. No.: US 2010/0002186 A1
(43) Pub. Date: Jan. 7, 2010

(54) Enclosure for Changing Eye Frame Designs

(76) Inventor: Gary Martin Zelman, Simi Valley, CA (US)

Correspondence Address: TROJAN LAW OFFICES, 9250 WILSHIRE BLVD, SUITE 325, BEVERLY HILLS, CA, 90212, US

(21) Appl. No.: 12/264,464

(22) Filed: Nov. 4, 2008

Related U.S. Application Data
(63) Continuation-in-part of application No. 12/167,059, filed on Jul. 2, 2008.

(51) Int. Cl. G02C 11/02

(52) U.S. Cl. 351/52

(57) ABSTRACT

Eyeglasses comprising a lens frame and a pair of temple frames, to which are attached decorative temple inserts by securing two temple extensions to form an enclosure for the temple inserts. The temple extensions, which are either plates or bars, are joined at one end by a hinge and are joined at the other end by an attachment apparatus. The temple inserts have protrusions that fit with recesses within the temple extensions, thereby stabilizing the inserts within the temple frame.

### RELATED PATENT APPLICATION

This application is a Continuation-In-Part application of application Ser. No. 12/167,059, filed Jul. 2, 2008.

### FIELD OF THE INVENTION

The present invention relates to eyewear. More specifically, the invention relates to attachment of decorative temple inserts to temple frames by securing two temple extensions to form an enclosure for the temple inserts.

### DESCRIPTION OF THE PRIOR ART

It is known in the art to attach decorative additions to a pair of eyeglasses. This has been achieved through various means, including the use of grooved channels and/or magnetic members.

U.S. Pat. No. 7,261,409 B1 issued to Taber discloses a means for securing decorative inserts to a pair of eyeglasses using a grooved channel. The temple frame is designed with a channel that allows a decorative insert to be slid into the temple frame at the hinge end, the end proximal to the lens frame. The decorative insert, when attached to a temple insert, is designed to fit the grooves of the channel, thereby securing the insert into the temple frame when the insert is completely slid into the temple frame.

One objective of the Taber patent is to allow a user of eyeglasses to quickly change the decorative inserts without the use of tools other than the user's hands. However, one disadvantage of securing the decorative inserts by merely using a grooved channel is that the inserts can readily slide out of the channel as easily as they can be put in. Because the channel is the only element securing the temple inserts, the temple inserts and the grooved channels must precisely fit each other in order to be secure. Another shortcoming of the grooved channel design is that the viewable portion of the decorative inserts must be limited to accommodate the groove structure. For example, in order to better secure the insert to the temple frame, one can design the grooves deeper. Unfortunately, the deeper the groove, the less viewable space is available for the decorative insert. Further, the Taber patent requires that the user take an additional step to attach the decorative piece to the temple insert before sliding the two pieces into the channel.

U.S. Pat. No. 6,089,707 issued to Shapiro also discloses a method for coupling a decorative coverlet to a temple frame of a pair of eyeglasses by using a channel design. The benefit of this design is that the entire outer portion of the coverlet is visible. As with the Taber patent, the Shapiro patent utilizes a channel design to secure the coverlet to the temple frame. Unlike the Taber patent, the Shapiro patent does not have the grooved features in the channel. The Shapiro patent instead uses magnets to secure the coverlet to the metal temple frame. The use of magnets severely limits the design and construction of the eyeglasses as it may be impractical or impossible to use magnetic members for certain frame designs.

The main objective of the Shapiro patent is to provide an eyeglass wearer with detachable sunglasses that do not sacrifice fashion to utility. Unfortunately, by requiring the use of magnetic materials, the Shapiro patent ultimately sacrifices utility and practicality.

U.S. application Ser. No. 11/338,881 submitted by Ifergan describes an eyeglass and a decorative attachment for mounting upon the eyeglass, wherein the eyeglass has a recess at each side portion with a magnetic member therein so as to receive a pin located at each end of the decorative attachment.

U.S. Pat. No. 5,181,051 issued to Townsend, et al. discloses eyeglasses made of a specified metal wherein magnetic retaining means are employed for temporarily retaining the “display.” Here, the “display” is a removable magnetic printed matter that serves to decorate and change the appearance of the eyeglasses.

The Shapiro patent, the Ifergan application, and the Townsend patent all teach the use of magnetic attraction between the eyeglass frame and the decorative insert in order to secure the two pieces. The obvious downside of these designs is that magnetic members must be attached to each decorative insert. As noted above, this can be impractical or impossible for some designs. Magnets increase the cost of materials and the cost of manufacturing. To add magnets as a component of the eyeglasses, the complexity of the manufacturing process increases significantly. The manufacturer must incorporate at least two additional steps: 1) the construction of the magnetic components and 2) the attachment of the magnetic components to the eyeglasses. Thus, it is preferable for an eyeglass manufacturer to minimize the use of magnetic components, or to eliminate magnets from the eyeglass design entirely.

Accordingly, what is needed is a method for attaching interchangeable decorations in a secure manner without restricting the functionality of the eyeglasses.

### SUMMARY OF THE INVENTION

The primary object of the invention is to provide a pair of eyeglasses in which decorative additions can be attached securely. A second object of the invention is to do so without using magnetic members as one of its composite materials.

In a first preferred embodiment, a lens frame is attached to a pair of temple frames, each temple frame consisting of two plates joined together by a hinge at the end proximate to the lens frame and joined by an attachment apparatus at the opposite end. There is no restriction as to the attachment method on the distal end (e.g., it can be a magnetic member, a clip, etc.), but the preferred attachment apparatus, for aesthetic reasons, would be one that is not visible when the plates are joined. Similarly, the hinge should be designed such that it is also not visible when the plates are joined.

Between the two plates rests an interchangeable temple insert, depicting a decorative pattern. The temple insert can be secured by a variety of methods. In one method, described hereinafter for simplicity as a first alignment variant, the temple insert is designed with two pins protruding above and two pins protruding below the temple insert. The two plates are structured such that they contain recesses that correspond with the shape, size, and location of the pins. A alignment variant of attaching the temple insert to the plates involves shaping the pins into hooks, thus providing an extra measure of stability. A third alignment variant provides protrusions running along the length of the temple insert, both above and below the temple insert. A fourth alignment variant involves protrusions from the temple insert that contain small holes. Pins protruding from plates, structured perpendicular to the plates and the temple insert, fit through the small holes in the temple insert to offer a stronger bond. A fifth alignment variant provides that the temple insert has either reflection symmetry or rotational symmetry along the long axis of the temple frame, thereby allowing the use of both sides of the temple insert for visible decorations.

Finally, the outer plate (the plate further away from the user's head) contains a window or opening so that the interchangeable temple inserts are clearly visible from the side when the user is wearing the eyeglasses. Ideally, the temple insert should be designed such that it is flush with the outer surface of the outer plate. Not only is this more aesthetically pleasing, but it also helps hold the temple inserts in place.

In a second preferred embodiment, a converse of the first, the hinge is attached to the distal end of the plates while the attachment apparatus is placed on the proximal end. It is preferred that the outer plate be permanently fixed to the lens frame whereas the inner frame is allowed to open for replacement of the temple inserts. In this embodiment, the plates are further steadied by the eyeglass wearer during use since the wearer's head prevents the inner plate from accidental release. An obvious variation of this embodiment would be to keep the inner plate fixed while the outer plate is allowed to open. This embodiment allows for easy replacement of the temple inserts, but lacks the stability of the first variant.

In a third preferred embodiment, the hinge is attached to either the superior end (i.e., top) or inferior end (i.e., bottom) of the plates while the attachment apparatus is placed on the end opposite the hinge. It is preferred that the outer plate be permanently fixed to the lens frame whereas the inner frame is allowed to open for replacement of the temple inserts. In this embodiment, the plates are further steadied by the eyeglass wearer during use since the wearer's head prevents the inner plate from accidental release. An obvious variation of this embodiment would be to keep the inner plate fixed while the outer plate is allowed to open. This embodiment allows for easy replacement of the temple inserts, but lacks the stability of the first variant.

In a fourth preferred embodiment, two temple bars replace the two plates. An upper bar and a lower bar each protrude from the proximal end of the temple frame and converge at the distal end of the temple frame. The two bars and the lens frame form a triangular opening in which an interchangeable temple insert can be placed. A hinge attaches to the proximate end of one of the bars, allowing that bar to rotate outward and away from the other bar, thereby allowing easy replacement of the temple insert. An attachment apparatus located at the convergence of the two bars secures the triangle. As in the previous embodiments, the temple insert and the temple frame can be designed with recesses and protrusions to better fasten the temple insert into place.

The fifth preferred embodiment is a converse of the fourth embodiment, placing the hinge at the convergence of the two bars and the attachment apparatus at the proximal end of one of the bars.

The sixth preferred embodiment is a variant of the five embodiments above, where the attachment apparatus is a sleeve that holds together the two temple plates or temple bars. At the temple end where the two plates/bars are to be joined, one or both of the plates/bars can be slid into the sleeve, thus securing the two plates/bars together. When properly designed, the sleeve also offers an additional benefit in that the sleeve aligns the two plates/bars. In an alternative embodiment, the sleeve can be designed to slide over and secure the two plates/bars together. This sleeve can be used in conjunction with other types of attachment apparatuses (e.g., a magnetic member, a clip, etc.) to provide better stability.

The above and other novel features of the invention will be more fully understood from the following detailed description and the accompanying drawings, in which:

### BRIEF DESCRIPTION OF THE DRAWINGS

FIG. 1 is an enlarged side perspective view of a lens frame and a temple frame in accordance with a first preferred embodiment of the present invention, the temple frame consisting of an inner plate and an outer plate, the two plates joined by a hinge at one end of the temple frame proximate to the lens frame and joined by an attachment apparatus at the opposite end of the temple frame.

FIG. 2 is an enlarged side perspective view of a lens frame and a temple frame in accordance with a second preferred embodiment of the present invention, the temple frame consisting of an inner plate and an outer plate, the two plates joined by an attachment apparatus at one end of the temple frame proximate to the lens frame and joined by a hinge at the opposite end of the temple frame.

FIG. 3 is an enlarged side perspective view of a lens frame and a temple frame in accordance with a third preferred embodiment of the present invention, the temple frame consisting of an inner plate and an outer plate, the two plates joined by a hinge at a superior end of the temple frame and joined by an attachment apparatus at the opposite end of the temple frame.

FIGS. 4 through 7 illustrate cross-sectional views of the temple frame showing three possible methods in which temple insert protrusions and the plates can interact, FIG. 4 corresponding to a first alignment variant and a third alignment variant of the present invention, FIG. 5 corresponding to a second alignment variant, FIG. 6 corresponding to a fourth alignment variant, FIG. 7 corresponding to a fifth alignment variant.

FIGS. 8 through 10 illustrate side perspective views of the temple insert and its protrusions, FIG. 8 corresponding to the first alignment variant of the present invention, FIG. 9 corresponding to the third alignment variant, FIG. 10 corresponding to the fourth alignment variant.

FIG. 11 is an enlarged side perspective view of a lens frame and a temple frame in accordance with a fourth preferred embodiment of the present invention, the temple frame consisting of an upper bar and a lower bar, one bar joined by a hinge to the proximate end of the temple frame, the two bars joined by an attachment apparatus at the opposite end of the temple frame.

FIG. 12 is an enlarged side perspective view of a lens frame and a temple frame in accordance with a fifth preferred embodiment of the present invention, the temple frame consisting of an upper bar and a lower bar, one bar joined to the proximate end of the temple frame by an attachment apparatus, the two bars joined by a hinge at the opposite end of the temple frame.

FIG. 13 is an enlarged side perspective view of a lens frame, a temple frame, and a temple insert secured and visible within the temple frame.

FIG. 14 illustrates a side perspective view of a lens frame, a temple frame, and a temple insert in accordance with a sixth preferred embodiment of the present invention; the temple frame consisting of two temple plates and a sleeve; where, as shown in this figure, the sleeve can slide off one or both of the temple plates.

FIG. 15 is a perspective view of a sixth preferred embodiment of the present invention, showing a lens frame, a temple frame, and a temple insert; the temple frame consisting of two temple plates and a sleeve (in this exemplar figure, the sleeve also functions as a temple tip); where, as shown in this figure, the temple frame can incorporate multiple attachment apparatuses, in this case a sleeve and a magnetic member.

FIG. 16 is a perspective view of another sixth preferred embodiment of the present invention, showing a lens frame, a temple frame, and a temple insert; the temple frame consisting of two temple plates and a sleeve; where, as shown in this figure, the temple frame can incorporate multiple attachment apparatuses, in this case a sleeve and a magnetic member.

### DETAILED DESCRIPTION OF THE INVENTION

The invention is for a pair of eyeglasses having temple frame designed to securely hold an interchangeable temple insert. Preferred embodiments of the present invention will now be described in detail with reference to the appended drawings, in which like elements are denoted with the same reference numerals.

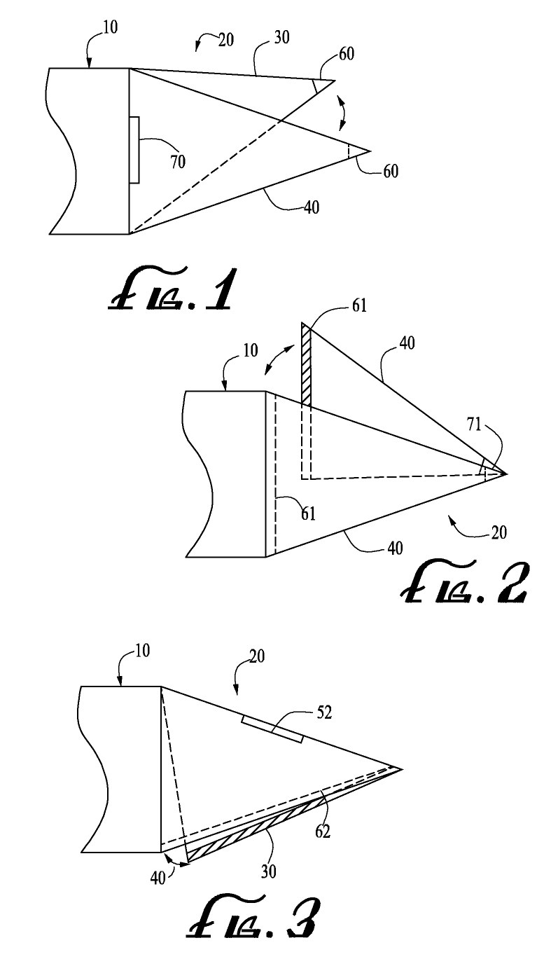

FIG. 1 is an enlarged side perspective view of a lens frame and a temple frame in accordance with a first preferred embodiment of the present invention. As shown, a lens frame 10 is connected to a temple frame 20. The temple frame 20 consists of an inner plate 30, located proximate to the eyeglass wearer's head, and an outer plate 40. The inner plate 30 and the outer plate 40 are joined by a hinge 50 at an end of the temple frame 20 proximate to the lens frame 10. At the opposite end of the temple frame 20, the inner plate 30 and the outer plate 40 are joined by an attachment apparatus 60.

FIG. 2 is an enlarged side perspective view of a lens frame and a temple frame in accordance with a second preferred embodiment of the present invention. As shown, a lens frame 10 is connected to a temple frame 20. The temple frame 20 consists of an inner plate 30, located proximate to the eyeglass wearer's head, and an outer plate 40. The inner plate 30 and the outer plate 40 are joined by an attachment apparatus 61 at an end of the temple frame 20 proximate to the lens frame 10. At the opposite end of the temple frame 20, the inner plate 30 and the outer plate 40 are joined by a hinge 51.

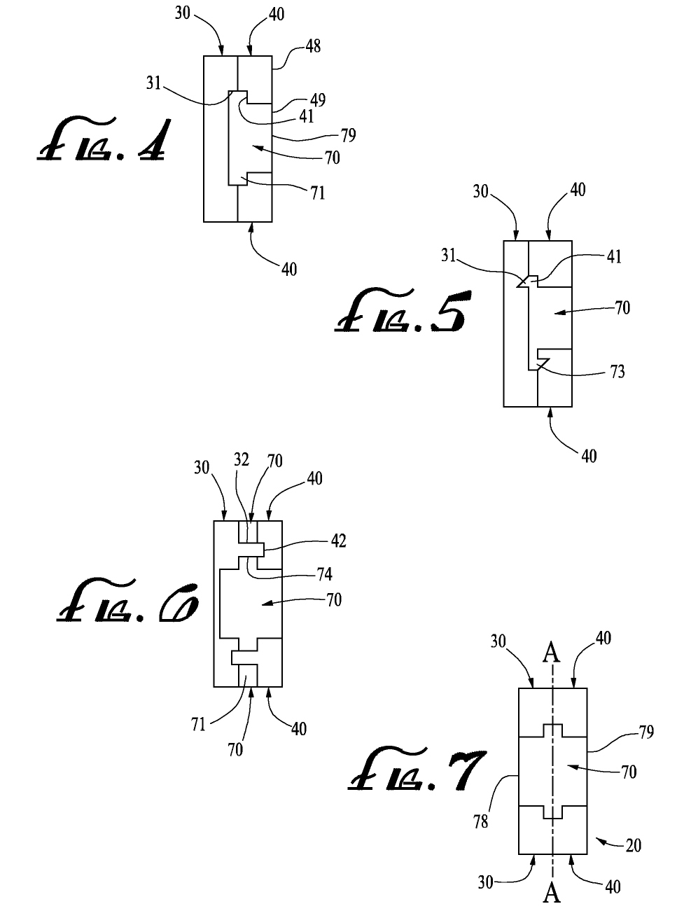

FIG. 3 is an enlarged side perspective view of a lens frame and a temple frame in accordance with a third preferred embodiment of the present invention. As shown, a lens frame 10 is connected to a temple frame 20. The temple frame 20 consists of an inner plate 30, located proximate to the eyeglass wearer's head, and an outer plate 40. The inner plate 30 and the outer plate 40 are joined by a hinge 52 at a superior end of the temple frame 20. At the opposite end of the temple frame 20, the inner plate 30 and the outer plate 40 are joined by an attachment apparatus 62.

FIG. 4 is a cross-sectional view of the temple frame corresponding to a first alignment variant and a third alignment variant of the present invention. As shown, an interchangeable temple insert 70 is sandwiched between an inner plate 30 and an outer plate 40. A recess 31 on the inner plate 30 and a recess 41 on the outer plate 40 hold securely the protrusion 71 of the temple insert 70. An opening or window 49 of the outer plate 40 allows the decorative surface 79 of the temple insert 70 to be visible when enclosed between the inner plate 30 and an outer plate 40. Ideally, the temple insert 70 is designed such that it is flush with the outer surface 48 of the outer plate 40.

FIG. 5 is a cross-sectional view of the temple frame corresponding to a second alignment variant of the present invention. As shown, an interchangeable temple insert 70 is sandwiched between an inner plate 30 and an outer plate 40. A recess 31 on the inner plate 30 and a recess 41 on the outer plate 40 hold securely the hook-shaped protrusion 73 of the temple insert 70.

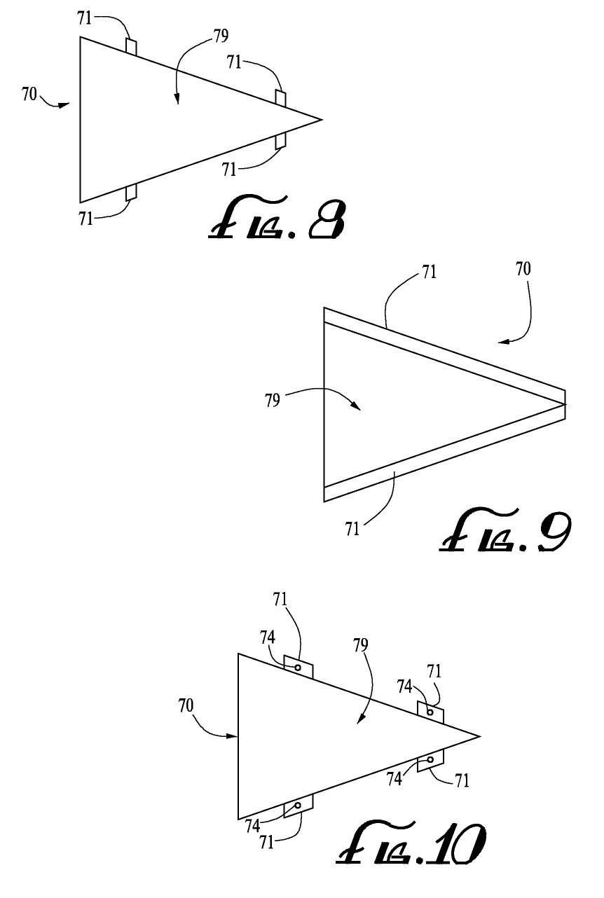

FIG. 6 is a cross-sectional view of the temple frame corresponding to a fourth alignment variant of the present invention. As shown, an interchangeable temple insert 70 is sandwiched between an inner plate 30 and an outer plate 40. A pin 32 protruding perpendicularly from the inner plate 30 goes through a channel 74 in the temple insert 70 and goes into a recess 42 in the outer plate 40.

FIG. 7 is a cross-sectional view of the temple frame corresponding to a fifth alignment variant of the present invention. As shown, an interchangeable temple insert 70 is sandwiched between an inner plate 30 and an outer plate 40. Because the temple insert 70 is symmetrical (here it has reflection symmetry) about its long axis 77, the temple insert 70 can be placed in the other temple frame (not shown). This allows for two different decorative surfaces 78 and 79 to be placed on the temple insert 70. Alternatively, if the temple insert 70 was rotationally symmetrical, then the temple insert 70 could instead be rotated and placed within the same temple frame 20.

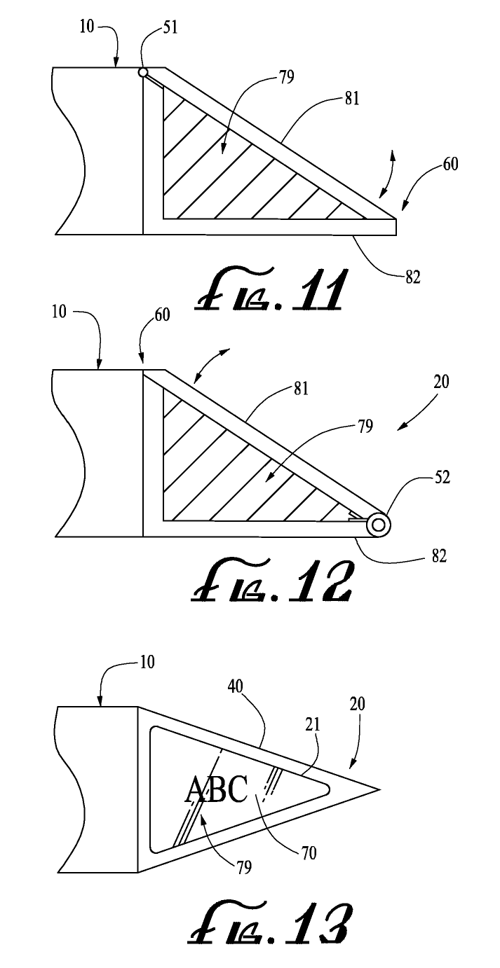

FIGS. 8 and 9 are side perspective views of the temple insert and its protrusions corresponding to a first alignment variant and a second alignment variant of the present invention respective. As shown, the temple insert 70 has a decorative surface 79, which is the only visible portion of the temple insert 70 when the temple insert 70 is sandwiched between the inner and outer plates (not shown). Protrusions 71 extend on top and below the decorative surface 79.

FIG. 10 is a side perspective view of the temple insert and its protrusions corresponding to a fourth alignment variant of the present invention respective. As shown, the temple insert 70 has a decorative surface 79, which is the only visible portion of the temple insert 70 when the temple insert 70 is sandwiched between the inner and outer plates (not shown). Protrusions 71 extend on top and below the decorative surface 79. Channels 74 are structured perpendicular to the protrusions 71 to allow pins of the inner and outer plates (not shown) through.

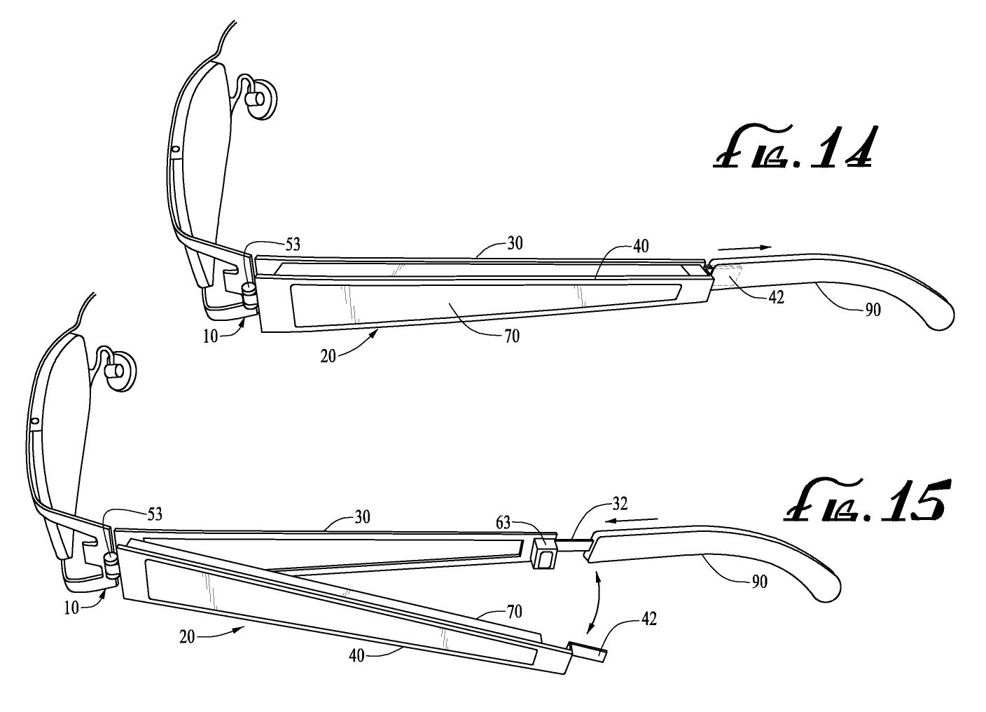

FIG. 11 is an enlarged side perspective view of a lens frame and a temple frame in accordance with a fourth preferred embodiment of the present invention. As shown, a lens frame 10 is connected to a temple frame 20. The temple frame 20 consists of an upper bar 81 and a lower bar 82. The upper bar 81 is joined by a hinge 50 to the lens frame 10. The lower bar 82 is fixed to the lens frame 10. At the end where the upper bar 81 and the lower bar 82 converge, the upper bar 81 and the lower bar 82 are joined by an attachment apparatus 60.

FIG. 12 is an enlarged side perspective view of a lens frame and a temple frame in accordance with a fifth preferred embodiment of the present invention. As shown, a lens frame 10 is connected to a temple frame 20. The temple frame 20 consists of an upper bar 81 and a lower bar 82. The upper bar 81 is joined by an attachment apparatus 60 to the lens frame 10. The lower bar 82 is fixed to the lens frame 10. At the end where the upper bar 81 and the lower bar 82 converge, the upper bar 81 and the lower bar 82 are joined by a hinge 50.

FIG. 13 is an enlarged side perspective view of a lens frame and a temple frame in accordance with the first, second, and third preferred embodiments of the present invention. As shown, a lens frame 10 is connected to a temple frame 20. A portion of the outer plate 40 is hollowed out to create a window 21. Through the window 21, the decorative surface 79 of the temple insert 70 is visible.

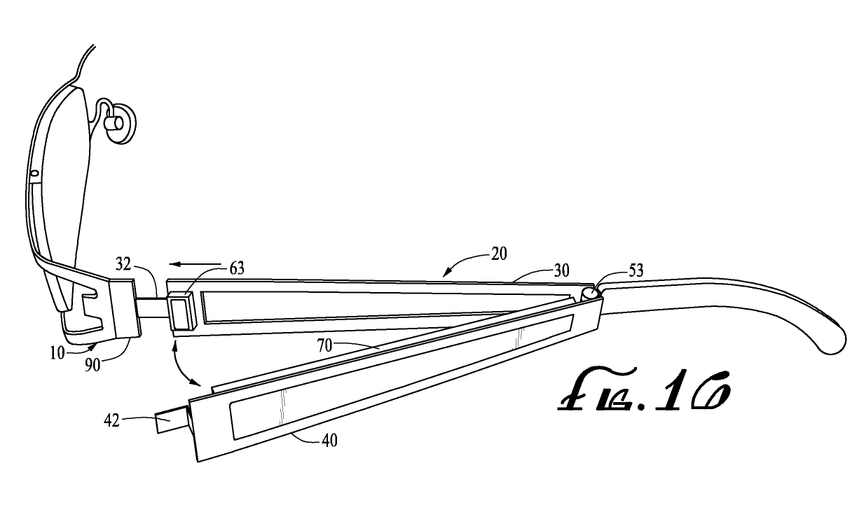

FIG. 14 illustrates a side perspective view of a lens frame, a temple frame, and a temple insert in accordance with a sixth preferred embodiment of the present invention. As shown, a lens frame 10 is connected to a temple frame 20, which can enclose a temple insert 70. The temple frame 20 consists of an outer temple plate 40, an inner temple plate (not shown), a hinge 53, and a sleeve 90. The sleeve 90 holds together a proximate tip 42 of the outer plate 40 with a proximate tip (not shown) of the inner plate (not shown). The sleeve 90 can slide off one or both of the proximate tips 42.

FIG. 15 is a perspective view of a sixth preferred embodiment of the present invention, showing a lens frame, a temple frame, and a temple insert. As shown, a lens frame 10 is connected to a temple frame 20, which can enclose a temple insert 70. The temple frame 20 consists of an outer temple plate 40, an inner temple plate 30, a hinge 53, and a sleeve 90. The sleeve 90 can slide over and hold together a proximate tip 42 of the outer plate 40 with a proximate tip 32 of the inner plate 30. As shown in this figure, the temple frame 20 can incorporate multiple attachment apparatuses, in this case a sleeve 90 and a magnetic member 63.

FIG. 16 is a perspective view of a sixth preferred embodiment of the present invention, showing a lens frame, a temple frame, and a temple insert. As shown, a lens frame 10 is connected to a temple frame 20, which can enclose a temple insert 70. The temple frame 20 consists of an outer temple plate 40, an inner temple plate 30, a hinge 53, and a sleeve 90. The sleeve 90 can slide over and hold together a proximate tip 42 of the outer plate 40 with a proximate tip 32 of the inner plate 30. As shown in this figure, the temple frame 20 can incorporate multiple attachment apparatuses, in this case a sleeve 90 and a magnetic member 63.

The invention has been described with reference to several different preferred and alternative embodiments and it is understood that any modifications thereto or alternate combinations thereof which would be readily apparent to one of ordinary skill in the art are intended to be encompassed. Therefore, the aforementioned descriptions are in no way intended to limit the breadth or scope of the invention as claimed hereinafter.

What is claimed is:

1. An eyeglass apparatus comprising:
a lens frame; and
a temple frame having a proximate end including:
an inner plate having a proximate end and a distal end;
an outer plate having a proximate end and a distal end;
an interchangeable temple insert;
a hinge; and
an attachment apparatus,
wherein, the hinge is attached to one end of the inner plate and the corresponding end of the outer plate, the attachment apparatus is attached to the opposite end of the inner plate and the corresponding end of the outer plate, the interchangeable temple insert is placed between the inner plate and the outer plate, and the proximate end of the temple frame is attached to the lens frame.

2. The eyeglass apparatus of claim 1, wherein the attachment apparatus is magnetic.

3. The eyeglass apparatus of claim 1, wherein the attachment apparatus is a clip.

4. The eyeglass apparatus of claim 1, wherein the interchangeable temple insert has at least one attachment device.

5. The eyeglass apparatus of claim 4, wherein the attachment device is a protruding member and the inner and outer plates have recesses designed to fit the protruding member.

6. The eyeglass apparatus of claim 5, wherein the protruding member is magnetic.

7. The eyeglass apparatus of claim 5, wherein the recesses are magnetic.

8. The eyeglass apparatus of claim 1, wherein at least one of the plates contains a window.

9. An eyeglass apparatus comprising:
a lens frame; and
a temple frame having a proximate end including:
an upper bar having a proximate end and a distal end;
an lower bar having a proximate end and a distal end;
an interchangeable temple insert;
a hinge; and
an attachment apparatus,
wherein, the hinge is attached to the proximate end of the temple frame and to the proximate end of at least one of the bars, the attachment apparatus is attached to the distal end of the upper bar and the distal end of the lower bar, the interchangeable temple insert is placed between the upper bar and the lower bar, and the proximate end of the temple frame is attached to the lens frame.

10. The eyeglass apparatus of claim 9, wherein the attachment apparatus is magnetic.

11. The eyeglass apparatus of claim 9, wherein the attachment apparatus is a clip.

12. The eyeglass apparatus of claim 9, wherein the interchangeable temple insert has at least one attachment device.

13. The eyeglass apparatus of claim 12, wherein the attachment device is a protruding member and the inner and outer plates have recesses designed to fit the protruding member.

14. The eyeglass apparatus of claim 13, wherein the protruding member is magnetic.

15. The eyeglass apparatus of claim 13, wherein the recesses are magnetic.

16. An eyeglass apparatus comprising:
a lens frame; and
a temple frame having a proximate end including:
an upper bar having a proximate end and a distal end;
an lower bar having a proximate end and a distal end;
an interchangeable temple insert;
a hinge; and
an attachment apparatus,
wherein, the hinge is attached to the distal end of the upper bar and to the distal end of the lower bar, the attachment apparatus is attached to the proximate end of at least one of the bars, the interchangeable temple insert is placed between the upper bar and the lower bar, and the proximate end of the temple frame is attached to the lens frame.

17. The eyeglass apparatus of claim 16, wherein the attachment apparatus is magnetic.

18. The eyeglass apparatus of claim 16, wherein the attachment apparatus is a clip.

19. The eyeglass apparatus of claim 16, wherein the interchangeable temple insert has at least one attachment device.

20. The eyeglass apparatus of claim 19, wherein the attachment device is a protruding member and the inner and outer plates have recesses designed to fit the protruding member.

21. The eyeglass apparatus of claim 20, wherein the protruding member is magnetic.

22. The eyeglass apparatus of claim 20, wherein the recesses are magnetic.
